(19) United States
(12) Patent Application Publication
(10) Pub. No.: US 2021/0195478 A1
(43) Pub. Date: Jun. 24, 2021

(54) CONFIGURATION OF NFRP TRIGGER FRAME FOR NDP FEEDBACK REPORT PROCEDURE

(71) Applicant: Intel Corporation, Santa Clara, CA (US)

(72) Inventors: Laurent Cariou, Portland, OR (US); Xiaogang Chen, Portland, OR (US); Thomas Kenney, Portland, OR (US)

(73) Assignee: Intel Corporation, Santa Clara, CA (US)

(21) Appl. No.: 17/121,788

(22) Filed: Dec. 15, 2020

(51) Int. Cl. H04W 36/00

(52) U.S. Cl. CPC H04W 36/0061; H04W 84/12; H04W 36/0058

(57) ABSTRACT

The disclosure provides techniques for configuration of a NFRP trigger frame for a NDP feedback report procedure. An apparatus may include interface circuitry; and processor circuitry coupled with the interface circuitry and configured to: encode a NFRP trigger frame in a PPDU; and provide the PPDU to the interface circuitry for transmission to a set of one or more STAs. A total bandwidth of the PPDU may be divided into one or more frequency segments, the NFRP trigger frame may include one or more User Info fields, and each User Info field may correspond to a respective frequency segment of the one or more frequency segments and provide NDP Feedback associated information for a subset of one or more STAs on the respective frequency segment.

### TECHNICAL FIELD

Embodiments described herein generally relate to wireless communication, and more specifically to configuration of a Neighbor Discovery Protocol (NDP) Feedback Report Poll (NFRP) trigger frame for a NDP feedback report procedure.

### BACKGROUND

New generation communication protocols (e.g. Institute of Electrical and Electronic Engineers (IEEE) 802.11be) for the Wireless Local Access Network (WLAN) have defined a very large Physical Protocol Data Unit (PPDU) bandwidth (e.g. up to 320 MHz), while in the previous generation communication protocols (e.g. IEEE 802.11ax) for the WLAN, the maximum PPDU bandwidth is 160 MHz. Additionally, the new generation communication protocols for the WLAN may introduce punctured operations where some frequency segments within the total bandwidth of the PPDU may not be used.

There is a NDP feedback report procedure defined in the previous generation communication protocols. The NDP feedback report procedure is based on a trigger frame which is adapted in order to allow multiple users to respond and provide a NDP feedback report response. In order to allow for the increased PPDU bandwidth and the punctured operations defined in the new generation communication protocols, the NDP feedback report procedure may need to be improved.

### BRIEF DESCRIPTION OF THE DRAWINGS

The various advantages of the embodiments will become apparent to one skilled in the art by reading the following specification and appended claims, and by referencing the following drawings, in which:

FIG. 1 shows an example configuration of a NFRP trigger frame for a NDP feedback report procedure according to some embodiments of the present disclosure;

FIG. 2 shows an example configuration of a NFRP trigger frame for a NDP feedback report procedure according to some embodiments of the present disclosure;

FIG. 3 shows a flowchart illustrating example operations associated with a NDP feedback procedure at an Access Point (AP) according to some embodiments of the present disclosure;

FIG. 4 shows a flowchart illustrating example operations associated with a NDP feedback procedure at a Station (STA) according to some embodiments of the present disclosure;

FIG. 5 shows a flowchart illustrating example operations associated with a NDP feedback procedure at an AP according to some embodiments of the present disclosure;

FIG. 6 shows a flowchart illustrating example operations associated with a NDP feedback procedure at a STA according to some embodiments of the present disclosure;

FIG. 7 shows a functional diagram of an exemplary communication device according to some embodiments of the present disclosure;

FIG. 8 shows a block diagram of an example of a machine or system upon which any one or more of the techniques discussed herein may be performed, according to some embodiments of the present disclosure;

FIG. 9 is a block diagram of a radio architecture according to some embodiments of the present disclosure;

FIG. 10 is a functional block diagram illustrating the WLAN FEM circuitry of FIG. 9, according to some embodiments of the present disclosure;

FIG. 11 is a functional block diagram illustrating the radio IC circuitry of FIG. 9, according to some embodiments of the present disclosure; and

FIG. 12 is a functional block diagram illustrating the baseband processing circuitry of FIG. 9, according to some embodiments of the present disclosure.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well-known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

New generation communication protocols (e.g. Institute of Electrical and Electronic Engineers (IEEE) 802.11be) for the Wireless Local Access Network (WLAN) have defined a very large Physical Protocol Data Unit (PPDU) bandwidth (e.g. up to 320 MHz), while in the previous generation communication protocols (e.g. IEEE 802.11ax) for the WLAN, the maximum PPDU bandwidth is 160 MHz. Additionally, the new generation communication protocols for the WLAN may introduce punctured operations where some frequency segments within the total bandwidth of the PPDU may not be used.

IEEE 802.11ax has defined a NDP feedback report procedure. The NDP feedback report procedure is based on a trigger frame which is adapted in order to allow multiple users to respond and provide a NDP feedback report response. The NDP feedback report response may be very short and require minimum signaling overhead using only a Physical Layer preamble in a Long Training Field (LTF) field. There is also defined a NDP Feedback Report Poll (NFRP) trigger frame, which provides NDP Feedback associated information for Stations (STAs) (e.g. non-AP STAs) to determine if they are allowed to respond to the NFRP trigger frame and determine the resource allocation on which they can send their feedback response.

In order to allow for the increased PPDU bandwidth and the punctured operations defined in the new generation communication protocols, the existing NDP feedback report procedure may need to be improved. In the present disclosure, it is proposed to divide the total bandwidth of the PPDU into multiple frequency segments and use the multiple frequency segments to implement the NDP feedback report procedure.

It should be noted that the description herein is dedicated to the IEEE 802.11 family, for example, 802.11ax (which is also called High-Efficiency Wireless (HEW) or Wireless Fidelity (Wi-Fi) 6), 802.11ac (which is also called 5th Generation of Wi-Fi (5G Wi-Fi)), and 802.11be, etc., but other technologies should be able to apply the same general concepts.

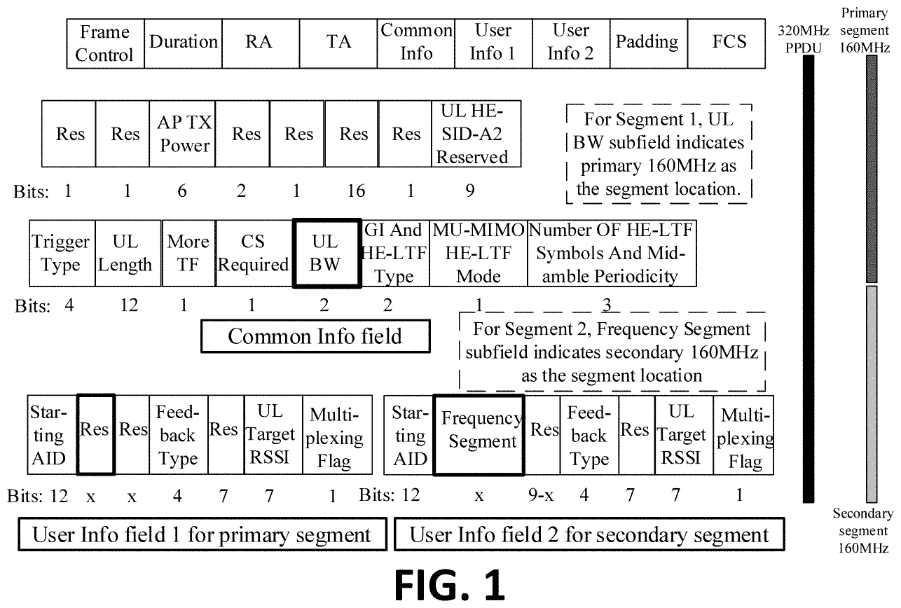

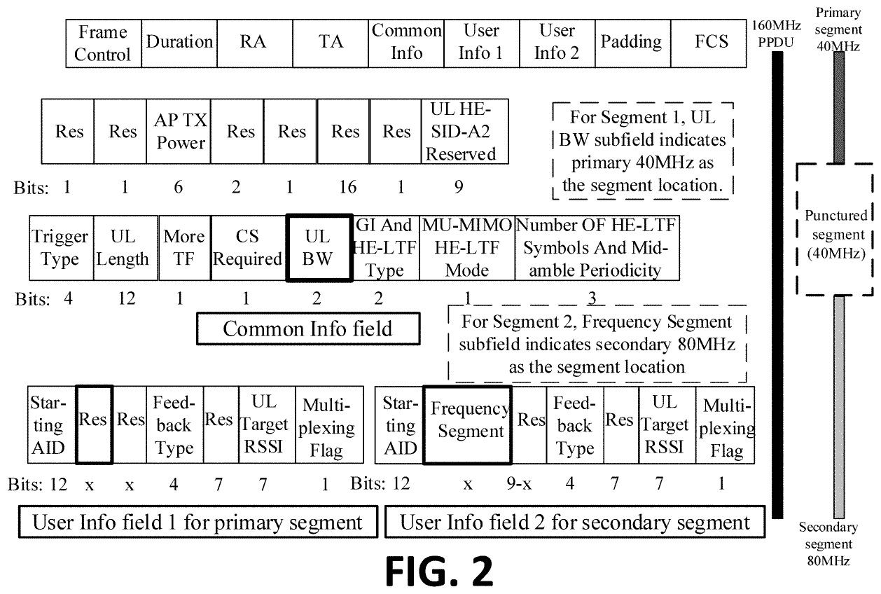

According to some embodiments of the present disclosure, an Access Point may generate a single NFRP trigger frame that can provide NDP Feedback associated information to multiple STAs on the multiple frequency segments. Specifically, the NFRP trigger frame may include multiple User Info fields respectively corresponds to the multiple frequency segments. Each User Info field may correspond to a respective frequency segment within the total PPDU bandwidth and provide NDP Feedback associated information to one or more STAs on the respective frequency segment. The configuration of the NFRP trigger frame will be described in detail below by referring to FIG. 1 and FIG. 2.

FIG. 1 shows an example configuration of a NFRP trigger frame for a NDP feedback report procedure according to some embodiments of the present disclosure.

As shown in FIG. 1, the total PPDU bandwidth may be 320 MHz, which may be divided into two frequency segments. The first frequency segment (Segment 1) may be a primary frequency segment of 160 MHz and the second frequency segment (Segment 2) may be a secondary frequency segment of 160 MHz. The NFRP trigger frame may include a Common Info field and one or more User Info fields. Since there are two frequency segments, the NFRP trigger frame may include two User Info fields such as User Info field 1 and User Info field 2. The User Info field 1 may correspond to the primary frequency segment of 160 MHz and the User Info field 2 may correspond to the secondary frequency segment of 160 MHz. The content of the User Info field 1 and the content of the User Info field 2 may be configured as shown in FIG. 1.

For example, the configuration of the User Info field 1 may be the same as the existing User Info field defined in IEEE 802.11ax and the Uplink (UL) Bandwidth (BW) subfield in the Common Info field may indicate the primary frequency segment of 160 MHz, while the User Info field 2 may include a Frequency Segment subfield to indicate the secondary frequency segment of 160 MHz. It is noted that the Frequency Segment subfield is a newly configured subfield in the User Info field for indicating a specific frequency segment corresponding to the User Info field.

The configuration of the NFRP trigger frame as shown in FIG. 1 is merely an example NFRP trigger frame adapted for the increased PPDU bandwidth according to some embodiments of the present disclosure. It should be understood that the NFRP trigger frame may be configured in other ways as long as each User Info field in the NFRP trigger frame may correspond to a respective frequency segment and provide NDP Feedback associated information for one or more STAs on the respective frequency segment. For example, the total bandwidth of the PPDU may be divided into multiple frequency segments as desired, the NFRP trigger frame may include multiple User Info fields respectively corresponding to the multiple frequency segments, and each User Info field may include a Frequency Segment subfield for indicating a location of the respective frequency segment within the total bandwidth of the PPDU.

Furthermore, the configuration of the NFRP trigger frame as shown in FIG. 1 may be similarly used when the total bandwidth of the PPDU includes a punctured frequency segment which will not be used for the NDP feedback report procedure. FIG. 2 shows an example configuration of a NFRP trigger frame for a NDP feedback report procedure according to some embodiments of the present disclosure.

As shown in FIG. 2, the total bandwidth of the PPDU may be 160 MHz as defined in the IEEE 802.11ax. However the total bandwidth may include a punctured frequency segment of 40 MHz and two available frequency segments which may be configured as a primary frequency segment (Segment 1) of 40 MHz and a secondary frequency segment (Segment 2) of 80 MHz. In this case, the NFRP trigger frame may include two User Info fields such as User Info field 1 and User Info field 2. The User Info field 1 may correspond to the primary frequency segment of 40 MHz and the User Info field 2 may correspond to the secondary frequency segment of 80 MHz.

In an example embodiment, the configuration of the User Info field 1 may be the same as the existing User Info field defined in IEEE 802.11ax and the UL BW subfield in the Common Info field may indicate the primary frequency segment of 40 MHz, while the User Info field 2 may include a Frequency Segment subfield to indicate the secondary frequency segment of 80 MHz.

Likewise, the configuration of the NFRP trigger frame as shown in FIG. 2 is merely an example NFRP trigger frame adapted for the punctured operations. It is obvious that the NFRP trigger frame may be configured in other ways as long as each User Info field in the NFRP trigger frame may correspond to a respective frequency segment and provide NDP Feedback associated information for one or more STAs on the respective frequency segment.

As described above, the configuration of the NFRP trigger frame may be adapted to allow for the increased PPDU bandwidth and the punctured operations. Meanwhile, some existing fields or subfields in the NFRP trigger frame as defined in the previous IEEE communication protocols such as 802.11ax may remain unchanged in the NFRP trigger frame as configured according to the embodiments of the present disclosure. Thus, the detailed configuration of the NFRP trigger frame will be described below with reference to the definition of the NFRP trigger frame in IEEE 802.11ax.

According to some embodiments of the present disclosure, the UL BW subfield in the Common Info field may indicate the bandwidth of the first frequency segment of the NDP feedback report response if the NFRP trigger frame includes multiple User Info fields, or may indicate the total bandwidth of the NDP feedback report response if the NFRP trigger frame includes a single User Info field. The NDP feedback report response may be encoded by a STA in a PPDU for transmission to the AP, so the total bandwidth of the NDP feedback report response may be the same as the total bandwidth of the PPDU herein. In some embodiments, if it is desired to provide the total bandwidth of the PPDU in addition to the bandwidth of the first frequency segment, a reserved bit in the Common Info field may be used to indicate the total bandwidth.

In addition, the subfields including Uplink (UL) Space Time Block Coding (STBC), Lower Density Parity Check Code (LDPC) Extra Symbol Segment, Pre-Forward-Error-Correction (Pre-FEC) Padding Factor, Packet Extension (PE) Disambiguity, UL Spatial Reuse, and Doppler in the Common Info field may be reserved. The Number of HE-LTF Symbols and Midamble Periodicity subfield in the Common Info field may indicate the number of HE-LTF symbols present in the NDP feedback report response and may be set to 1. The GI and HE-LTF Type subfield in the Common Info field may be set to 2. The Trigger Dependent Common Info subfield may be not present.

The User Info field for the NFRP trigger frame may be defined in the following Table 1 according to the IEEE 802.11ax.

TABLE 1

| | Starting | | Feedback | | UL Target | Multiplexing |
|---|---|---|---|---|---|---|
| | AID | Reserved | Type | Reserved | RSSI | Flag |
| Bits | 12 | 9 | 4 | 7 | 7 | 1 |

According to some embodiments of the present disclosure, when the total bandwidth of the PPDU is divided into multiple frequency segments and the NFRP trigger frame includes multiple User Info fields, each User Info field (or each User Info field corresponding a secondary frequency segment) may be defined in the following Table 2.

TABLE 2

| | Starting | Frequency | | Feedback | | UL Target | Multiplexing |
|---|---|---|---|---|---|---|---|
| | AID | Segment | Reserved | Type | Reserved | RSSI | Flag |
| Bits | 12 | x | 9-x | 4 | 7 | 7 | 1 |

As illustrated in Table 2, the Frequency Segment subfield in the User Info field may consist of x bits and indicate a location of a specific frequency segment corresponding to the User Info field within the total bandwidth of the NDP feedback report response. For example, it may be assumed that the bandwidth of the frequency segment is multiple of 20 MHz, then the bits required for indicating the frequency segment may be 3 bits.

An example of the Feedback Type subfield encoding may be defined in the following Table 3.

TABLE 3
An example of Feedback Type subfield encoding

| Value | Description |
|---|---|
| 0 | Resource request |
| 1 | Resource request on a frequency segment |
| 2 | New type 1 on a frequency segment |
| 3 | New type 1 |
| 4 | New type 2 on a frequency segment |
| 5-15 | Reserved |

According to the example of the Feedback Type subfield encoding as shown in Table 3, in the case that the Feedback Type is equal to 0 or 3 for the NDP feedback report procedure on the total PPDU bandwidth without the divided frequency segments, the scheduled non-AP High Efficiency (HE) STAs may be identified by a range of AIDs. The Starting AID subfield may define the first AID of the range of AIDs that are scheduled to respond to the NFRP Trigger frame. The UL Target Received Signal Strength Indication (RSSI) subfield may indicate the target RSSI at the receiver's antenna connector(s), over the subcarriers assigned to a scheduled STA within the PPDU bandwidth, from the HE portion of the HE TB feedback NDP, averaged over all antennas used to receive the PPDU for each of the scheduled STAs. The resolution for the UL Target RSSI subfield may be 1 dB. The UL Target RSSI subfield encoding is defined in Table 9-31i of the IEEE 802.11ax.

In the case that the Feedback Type is equal to 0 or 3 for the NDP feedback report procedure on the total PPDU bandwidth without the divided frequency segments, the Multiplexing Flag subfield may indicate the number of STAs that are multiplexed on the same set of tones in the same RU, and may be encoded as the number of STAs minus 1. Thus the total number of STAs, N_{STA}, that are scheduled to respond to the NFRP Trigger frame may be calculated using the following Equation (1).

N_{STA}=18×2^{BW}×(MultiplexingFlag+1) (1)

In Equation (1), BW is the value of the UL BW subfield in the Common Info field of the NFRP Trigger frame, and MultiplexingFlag is the value of the Multiplexing Flag subfield.

In the case that the Feedback Type is equal to 1, 2 or 4 for the NDP feedback report procedure on a frequency segment within the total PPDU bandwidth, the scheduled non-AP High Efficiency (HE) STAs may be identified by a range of AIDs. The Starting AID subfield may define the first AID of the range of AIDs that are scheduled to respond to the NFRP Trigger frame. The UL Target Received Signal Strength Indication (RSSI) subfield may indicate the target RSSI at the receiver's antenna connector(s), over the subcarriers assigned to a scheduled STA within the PPDU bandwidth, from the HE portion of the HE TB feedback NDP, averaged over all antennas used to receive the PPDU for each of the scheduled STAs. The resolution for the UL Target RSSI subfield may be 1 dB. The UL Target RSSI subfield encoding is defined in the IEEE 802.11ax.

In addition, in the case that the Feedback Type is equal to 1, 2 or 4 for the NDP feedback report procedure on a frequency segment within the total PPDU bandwidth, the Multiplexing Flag subfield may indicate the number of STAs that are multiplexed on the same set of tones in the same RU, and may be encoded as the number of STAs minus 1. Thus the total number of STAs, N_{STA}, that are scheduled to respond to the NFRP Trigger frame on the frequency segment identified by the User Info field may be calculated using the following Equation (2).

N_{STA}=18×2^{FreqSegmentSize}×(MultiplexingFlag+1) (2)

In Equation (2), FreqSegmentSize is the bandwidth of the frequency segment corresponding to the User Info field as indicated in the Frequency Segment subfield, and MultiplexingFlag is the value of the Multiplexing Flag subfield.

It is noted that if there is only a single User Info field in the NFRP trigger frame, the Frequency Segment subfield in the User Info field may be reserved, while if there are multiple User Info fields in the NFRP trigger frame, the Frequency Segment subfield in each User Info field may indicate the location of the frequency segment corresponding to the User Info field within the total bandwidth of the PPDU.

For example, when the total bandwidth of the PPDU is 320 MHz, the first frequency segment may be a primary frequency segment of 160 MHz which may corresponds to a first User Info field that can be understood by a 802.11ax STA and may be indicated by the UL BW subfield in the Common Info field of the NFRP trigger frame; the second frequency segment may be a secondary frequency segment of 80 MHz and may be indicated by the Frequency Segment subfield of a second User Info field; and the third frequency segment may be another secondary frequency segment of 80 MHz and may be indicated by the Frequency Segment subfield of a third User Info field. In this case, for example, by setting the Feedback Type subfields in the second User Info field and the third User Info field to be a value that a 802.11ax STA cannot understand but a 802.11be or Extremely High Throughput (EHT) STA can understand, the 802.11ax STA may ignore the second User Info field and the third User Info field but the 802.11be/EHT STA may identify the second User Info field and the third User Info field and respond to the NFRP trigger frame on the respective frequency segments.

In some embodiments of the present disclosure, the NFRP trigger frame may further include an additional User Info field to carry common NDP Feedback associated information for the STAs receiving the NFRP. For example, the additional User Info field may include a Starting AID subfield that is set to a specified value to identify the additional User Info field as a new Info field for carrying the common NDP Feedback associated information for the STAs.

According to the above description about the configuration of the NFRP trigger frame, it should be understood that the NDP Feedback associated information herein may include the information carried in the User Info fields, such as the Feedback Type, the Starting AID, the Frequency Segment, the Multiplexing Flag and the like, that can be used by the STAs to determine if they are allowed to respond to the NFRP trigger frame and determine the resource allocation on which they can send their feedback response.

As described above, the AP may use a single NFRP trigger frame to provide NDP Feedback associated information to multiple STAs on multiple frequency segments. Alternatively, according to some embodiments of the present disclosure, the AP may aggregate multiple NFRP trigger frames each of which corresponds to a respective frequency segment of the multiple frequency segments within the total PPDU bandwidth and provides the NDP Feedback associated information to multiple STAs on the respective frequency segment.

For example, the AP may aggregate the multiple NFRP trigger frames in an Aggregation Medium Access Control Protocol Data Unit (A-MPDU) and broadcast the A-MPDU to a set of STAs. The NFRP trigger frames may be designed to correspond to frequency segments that may not include a primary frequency segment that can be understood by a 802.11ax STA, so that the 802.11ax STA may ignore the NFRP trigger frames and a 802.11be/EHT STA may be able to identify the NFRP trigger frames and determine which frequency segments the NFRP trigger frames may correspond to.

In the embodiments where the AP aggregate multiple NFRP trigger frames to provide NDP Feedback associated information on multiple frequency segments, the Common Info field and the User Info field of each NFRP trigger frame may be configured in a similar way as the foregoing embodiments where the AP uses a single NFRP trigger frame including multiple User Info field to provide NDP Feedback associated information on multiple frequency segments. For example, the UL BW subfield in the Common Info field of the NFRP trigger frame may indicate the first frequency segment within the total PPDU bandwidth, the User Info field of the NFRP trigger frame may include a Frequency Segment subfield to indicate the frequency segment corresponding to the NFRP trigger frame, and the like. Thus for sake of conciseness, the details about the Common Info field and the User Info field of the NFRP trigger frame in these embodiments will be omitted herein.

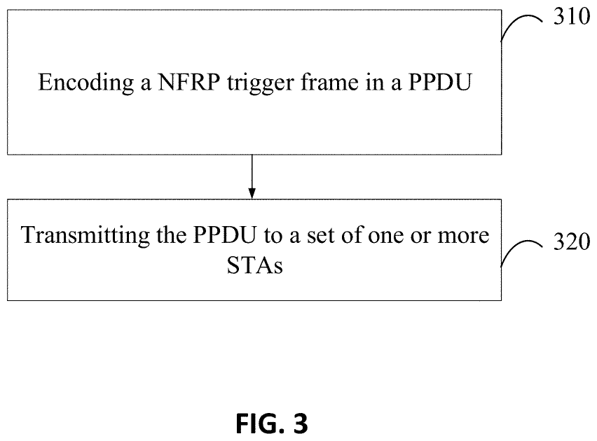

According to the above description, it is clear that the NDP feedback report procedure may involve at least the AP and the STA, so the operations associated the NDP feedback report procedure at the AP and the STA will be described below respectively with reference to FIG. 3 to FIG. 6.

FIG. 3 shows a flowchart illustrating example operations associated with a NDP feedback procedure at an AP according to some embodiments of the present disclosure. The operations associated with the NDP feedback procedure at the AP may include operations 310 and 320.

At operation 310, the AP may encode a NFRP trigger frame in a PPDU.

At operation 320, the AP may transmit the PPDU to a set of one or more STAs.

The total bandwidth of the PPDU may be divided into one or more frequency segments. The NFRP trigger frame may include one or more User Info fields, and each User Info field may correspond to a respective frequency segment of the one or more frequency segments and provide NDP Feedback associated information for a subset of one or more STAs on the respective frequency segment.

The total bandwidth may be 20 MHz, 40 MHz, 80 MHz, 160 MHz or 320 MHz. The total bandwidth may include a punctured frequency segment not used for a NDP feedback report procedure. The one or more frequency segments may be distributed on both side of the punctured frequency segment.

The User Info field may include a Frequency Segment subfield for indicating a location of the respective frequency segment within the total bandwidth. The one or more frequency segments may include a primary frequency segment and a secondary frequency segment, and a User Info field corresponding to the secondary frequency segment may include a Frequency Segment subfield for indicating a location of the secondary frequency segment within the total bandwidth.

The User Info field may include a Starting AID subfield indicating a first AID of a range of AIDs of the subset of one or more STAs that are scheduled to respond to the NFRP trigger frame.

The User Info field may include a Feedback Type subfield indicating a feedback type for a NDP feedback report procedure on the respective frequency segment.

The User Info field may include a Multiplexing Flag subfield indicating a number of STAs that are multiplexed on a same set of tones in a same RU. A total number N_{STA} of STAs in the subset of one or more STAs that are scheduled to respond to the NFRP trigger frame may be calculated by N_{STA}=18×2^{FreqSegmentsize}×(MultiplexingFlag+1), where FreqSegmentsize is a bandwidth of the respective frequency segment corresponding to the User Info field and MultiplexingFlag is a value of the Multiplexing Flag subfield.

The NFRP trigger frame may further include a Common Info field including an UL BW subfield. The UL BW subfield may indicate the total bandwidth when the one or more User Info fields include a single User Info field and may indicate a bandwidth of a first frequency segment of the one or more frequency segments when the one or more User Info fields include two or more User Info fields. When the one or more User Info fields include two or more User Info fields, a reserved bit in the Common Info field may be used to indicate the total bandwidth.

The NFRP trigger frame may further include an additional User Info field to carry common NDP Feedback associated information for the set of one or more STAs. The additional User Info field may include a Starting AID subfield that is set to a specified value to identify the additional User Info field as a new Info field for carrying the common NDP Feedback associated information for the set of one or more STAs.

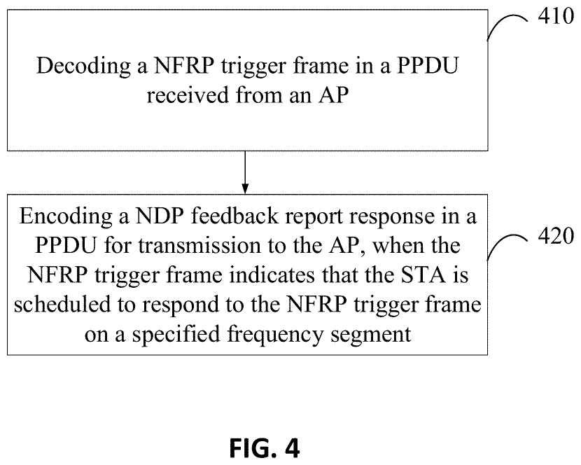

FIG. 4 shows a flowchart illustrating example operations associated with a NDP feedback procedure at a STA according to some embodiments of the present disclosure. The operations associated with the NDP feedback procedure at the STA may include operations 410 and 420.

At operation 410, the STA may decode a NFRP trigger frame in a PPDU received from an AP.

The configuration of the NFRP trigger frame may be the same as the configuration of the NFRP trigger frame as described above referring to FIG. 3, so the details about the configuration of the NFRP trigger frame will be omitted herein for sake of conciseness.

At operation 420, the STA may encode a NDP feedback report response in a PPDU for transmission to the AP, when the NFRP trigger frame indicates that the STA is scheduled to respond to the NFRP trigger frame on a specified frequency segment.

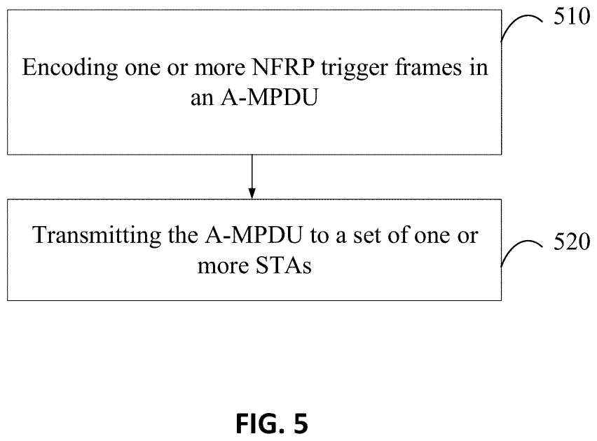

FIG. 5 shows a flowchart illustrating example operations associated with a NDP feedback procedure at an AP according to some embodiments of the present disclosure. The operations associated with the NDP feedback procedure at the AP may include operations 510 and 520.

At operation 510, the AP may encode one or more NFRP trigger frames in an A-MPDU.

At operation 520, the AP may transmit the A-MPDU to a set of one or more STAs.

The total bandwidth of the PPDU may be divided into one or more frequency segments, and each NFRP trigger frame may correspond to a respective frequency segment of the one or more frequency segments and provide NDP Feedback associated information for a subset of one or more STAs on the respective frequency segment.

The total bandwidth may be 20 MHz, 40 MHz, 80 MHz, 160 MHz or 320 MHz. The total bandwidth may include a punctured frequency segment not used for a NDP feedback report procedure. The one or more frequency segments may be distributed on both side of the punctured frequency segment.

The NFRP trigger frame may include a User Info field that includes a Frequency Segment subfield to indicate a location of the respective frequency segment within the total bandwidth. The one or more frequency segments may include a primary frequency segment and a secondary frequency segment, and a NFRP trigger frame corresponding to the secondary frequency segment may include a User Info field that includes a Frequency Segment subfield to indicate a location of the secondary frequency segment within the total bandwidth.

The NFRP trigger frame may further include a Common Info field including an UL BW subfield. The UL BW subfield may indicate the total bandwidth when the one or more NFPR trigger frames include a single NFRP trigger frame and may indicate a bandwidth of a first frequency segment of the one or more frequency segments when the one or more NFRP trigger frames include two or more NFRP trigger frames.

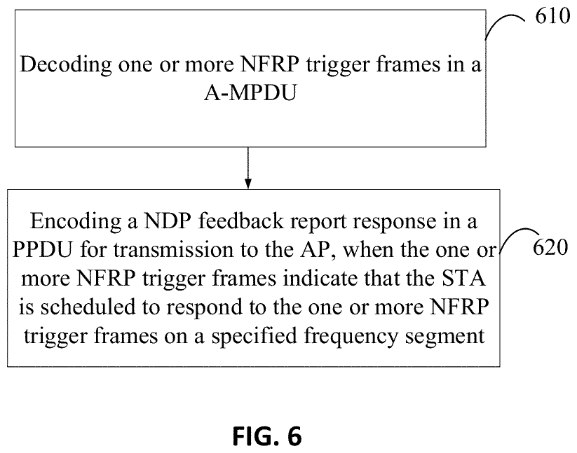

FIG. 6 shows a flowchart illustrating example operations associated with a NDP feedback procedure at a Station (STA) according to some embodiments of the present disclosure. The operations associated with the NDP feedback procedure at the STA may include operations 610 and 620.

At operation 610, the STA may decode one or more NFRP trigger frames in an A-MPDU received from an AP.

The configuration of the NFRP trigger frames may be the same as the configuration of the NFRP trigger frame as described above referring to FIG. 5, so the details about the configuration of the NFRP trigger frames will be omitted herein for sake of conciseness.

At operation 620, the STA may encode a NDP feedback report response in a PPDU for transmission to the AP, when the one or more NFRP trigger frames indicate that the STA is scheduled to respond to the one or more NFRP trigger frames on a specified frequency segment.

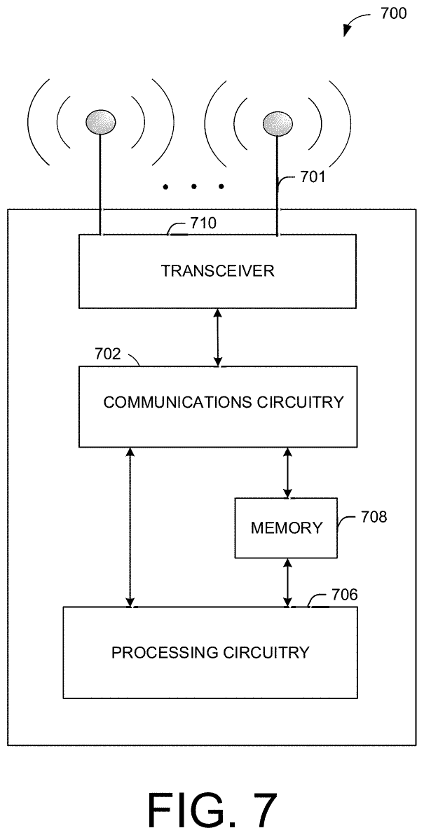

FIG. 7 shows a functional diagram of an exemplary communication device 700, in accordance with one or more example embodiments of the disclosure. In one embodiment, FIG. 7 illustrates a functional block diagram of a communication device that may be suitable for use as the AP(s) or the STA(s) in accordance with some embodiments. The communication device 700 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication device 700 may include communications circuitry 702 and a transceiver 710 for transmitting and receiving signals to and from other communication stations using one or more antennas 701. The communications circuitry 702 may include circuitry that can operate the physical layer (PHY) communications and/or medium access control (MAC) communications for controlling access to the wireless medium, and/or any other communications layers for transmitting and receiving signals. The communication device 700 may also include processing circuitry 706 and memory 708 arranged to perform the operations described herein. In some embodiments, the communications circuitry 702 and the processing circuitry 706 may be configured to perform operations detailed in the above figures, diagrams, and flows.

In accordance with some embodiments, the communications circuitry 702 may be arranged to contend for a wireless medium and configure frames or packets for communicating over the wireless medium. The communications circuitry 702 may be arranged to transmit and receive signals. The communications circuitry 702 may also include circuitry for modulation/demodulation, upconversion/downconversion, filtering, amplification, etc. In some embodiments, the processing circuitry 706 of the communication device 700 may include one or more processors. In other embodiments, two or more antennas 701 may be coupled to the communications circuitry 702 arranged for transmitting and receiving signals. The memory 708 may store information for configuring the processing circuitry 706 to perform operations for configuring and transmitting message frames and performing the various operations described herein. The memory 708 may include any type of memory, including non-transitory memory, for storing information in a form readable by a machine (e.g., a computer). For example, the memory 708 may include a computer-readable storage device, read-only memory (ROM), random-access memory (RAM), magnetic disk storage media, optical storage media, flash-memory devices and other storage devices and media.

In some embodiments, the communication device 700 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication device 700 may include one or more antennas 701. The antennas 701 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication device 700 may include one or more of a keyboard, a display, a non-volatile memory port, multiple antennas, a graphics processor, an application processor, speakers, and other mobile device elements. The display may be a liquid crystal display (LCD) screen including a touch screen.

Although the communication device 700 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication device 700 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication device 700 may include one or more processors and may be configured with instructions stored on a computer-readable storage device.

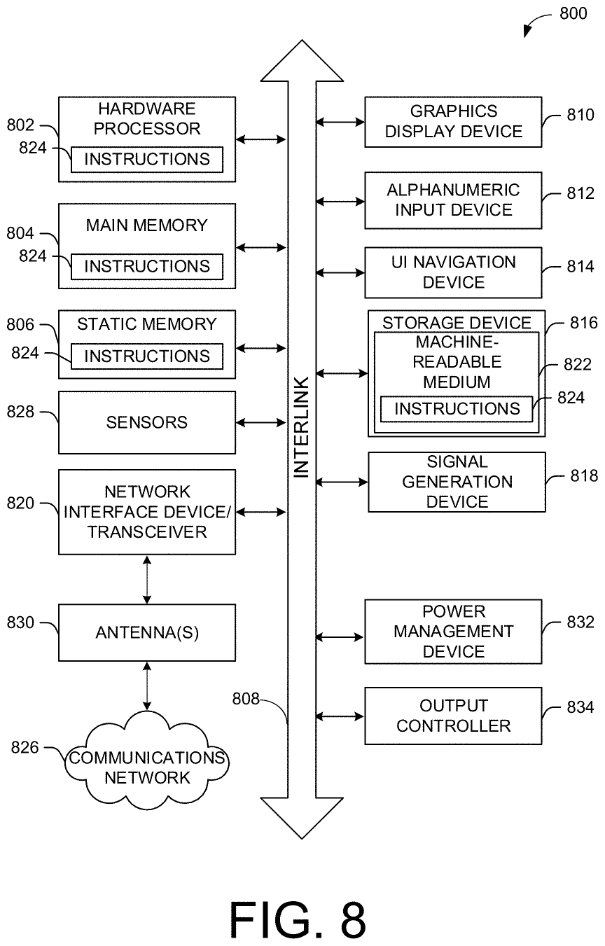

FIG. 8 illustrates a block diagram of an example of a machine 800 upon which any one or more of the techniques (e.g., methodologies) discussed herein may be performed. In other embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environments. The machine 800 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a power management device 832, a graphics display device 810, an alphanumeric input device 812 (e.g., a keyboard), and a user interface (UI) navigation device 814 (e.g., a mouse). In an example, the graphics display device 810, alphanumeric input device 812, and UI navigation device 814 may be a touch screen display. The machine 800 may additionally include a storage device (i.e., drive unit) 816, a signal generation device 818 (e.g., a speaker), a network interface device/transceiver 820 coupled to antenna(s) 830, and one or more sensors 828, such as a global positioning system (GPS) sensor, a compass, an accelerometer, or other sensor. The machine 800 may include an output controller 834, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the disclosure may be carried out by a baseband processor. The baseband processor may be configured to generate corresponding baseband signals. The baseband processor may further include physical layer (PHY) and medium access control layer (MAC) circuitry, and may further interface with the hardware processor 802 for generation and processing of the baseband signals and for controlling operations of the main memory 804, and/or the storage device 816. The baseband processor may be provided on a single radio card, a single chip, or an integrated circuit (IC).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within the static memory 806, or within the hardware processor 802 during execution thereof by the machine 800. In an example, one or any combination of the hardware processor 802, the main memory 804, the static memory 806, or the storage device 816 may constitute machine-readable media.

While the machine-readable medium 822 is illustrated as a single medium, the term “machine-readable medium” may include a single medium or multiple media (e.g., a centralized or distributed database, and/or associated caches and servers) configured to store the one or more instructions 824.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 800 and that cause the machine 800 to perform any one or more of the techniques of the disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device/transceiver 820 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 820 may include one or more physical jacks (e.g., Ethernet, coaxial, or phone jacks) or one or more antennas to connect to the communications network 826. In an example, the network interface device/transceiver 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 800 and includes digital or analog communications signals or other intangible media to facilitate communication of such software. The instructions may implement one or more aspects of the methods/processes described above, including the operations of FIG. 3, the operations of FIG. 4, the operations of FIG. 5, and the operations of FIG. 6 as described herein.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

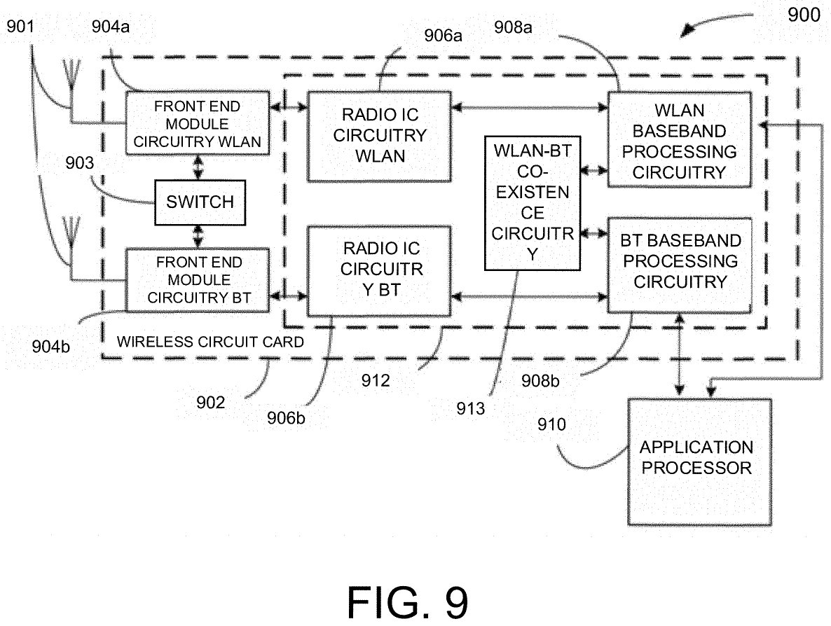

FIG. 9 is a block diagram of a radio architecture 900 in accordance with some embodiments. The radio architecture 900 may be implemented in any of the AP(s) and/or STA(s). Radio architecture 900 may include radio front-end module (FEM) circuitry 904a-b, radio IC circuitry 906a-b and baseband processing circuitry 908a-b. Radio architecture 900 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 904a-b may include a WLAN or Wi-Fi FEM circuitry 904a and a Bluetooth (BT) FEM circuitry 904b. The WLAN FEM circuitry 904a may include a receive signal path comprising circuitry configured to operate on WLAN RF signals received from one or more antennas 901, to amplify the received signals and to provide the amplified versions of the received signals to the WLAN radio IC circuitry 906a for further processing. The BT FEM circuitry 904b may include a receive signal path which may include circuitry configured to operate on BT RF signals received from one or more antennas 901, to amplify the received signals and to provide the amplified versions of the received signals to the BT radio IC circuitry 906b for further processing. FEM circuitry 904a may also include a transmit signal path which may include circuitry configured to amplify WLAN signals provided by the radio IC circuitry 906a for wireless transmission by one or more of the antennas 901. In addition, FEM circuitry 904b may also include a transmit signal path which may include circuitry configured to amplify BT signals provided by the radio IC circuitry 906b for wireless transmission by the one or more antennas. In the embodiment of FIG. 9, although FEM 904a and FEM 904b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 906a-b as shown may include WLAN radio IC circuitry 906a and BT radio IC circuitry 906b. The WLAN radio IC circuitry 906a may include a receive signal path which may include circuitry to down-convert WLAN RF signals received from the FEM circuitry 904a and provide baseband signals to WLAN baseband processing circuitry 908a. BT radio IC circuitry 906b may in turn include a receive signal path which may include circuitry to down-convert BT RF signals received from the FEM circuitry 904b and provide baseband signals to BT baseband processing circuitry 908b. WLAN radio IC circuitry 906a may also include a transmit signal path which may include circuitry to up-convert WLAN baseband signals provided by the WLAN baseband processing circuitry 908a and provide WLAN RF output signals to the FEM circuitry 904a for subsequent wireless transmission by the one or more antennas 901. BT radio IC circuitry 906b may also include a transmit signal path which may include circuitry to up-convert BT baseband signals provided by the BT baseband processing circuitry 908b and provide BT RF output signals to the FEM circuitry 904b for subsequent wireless transmission by the one or more antennas 901. In the embodiment of FIG. 9, although radio IC circuitries 906a and 906b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 908a-b may include a WLAN baseband processing circuitry 908a and a BT baseband processing circuitry 908b. The WLAN baseband processing circuitry 908a may include a memory, such as, for example, a set of RAM arrays in a Fast Fourier Transform or Inverse Fast Fourier Transform block (not shown) of the WLAN baseband processing circuitry 908a. Each of the WLAN baseband circuitry 908a and the BT baseb and circuitry 908b may further include one or more processors and control logic to process the signals received from the corresponding WLAN or BT receive signal path of the radio IC circuitry 906a-b, and to also generate corresponding WLAN or BT baseband signals for the transmit signal path of the radio IC circuitry 906a-b. Each of the baseband processing circuitries 908a and 908b may further include physical layer (PHY) and medium access control layer (MAC) circuitry, and may further interface with a device for generation and processing of the baseband signals and for controlling operations of the radio IC circuitry 906a-b.

Referring still to FIG. 9, according to the shown embodiment, WLAN-BT coexistence circuitry 913 may include logic providing an interface between the WLAN baseband circuitry 908a and the BT baseband circuitry 908b to enable use cases requiring WLAN and BT coexistence. In addition, a switch 903 may be provided between the WLAN FEM circuitry 904a and the BT FEM circuitry 904b to allow switching between the WLAN and BT radios according to application needs. In addition, although the antennas 901 are depicted as being respectively connected to the WLAN FEM circuitry 904a and the BT FEM circuitry 904b, embodiments include within their scope the sharing of one or more antennas as between the WLAN and BT FEMs, or the provision of more than one antenna connected to each of FEM 904a or 904b.

In some embodiments, the front-end module circuitry 904a-b, the radio IC circuitry 906a-b, and baseband processing circuitry 908a-b may be provided on a single radio card, such as wireless radio card 9. In some other embodiments, the one or more antennas 901, the FEM circuitry 904a-b and the radio IC circuitry 906a-b may be provided on a single radio card. In some other embodiments, the radio IC circuitry 906a-b and the baseband processing circuitry 908a-b may be provided on a single chip or integrated circuit (IC), such as IC 912.

In some embodiments, the wireless radio card 902 may include a WLAN radio card and may be configured for Wi-Fi communications, although the scope of the embodiments is not limited in this respect. In some of these embodiments, the radio architecture 900 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 900 may be part of a Wi-Fi communication station (STA) such as a wireless access point (AP), a base station or a mobile device including a Wi-Fi device. In some of these embodiments, radio architecture 900 may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay, 802.11ax and/or 802.11be standards and/or proposed specifications for WLANs, although the scope of embodiments is not limited in this respect. Radio architecture 900 may also be suitable to transmit and/or receive communications in accordance with other techniques and standards.

In some embodiments, the radio architecture 900 may be configured for high-efficiency Wi-Fi (HEW) communications in accordance with the IEEE 802.11ax standard. In these embodiments, the radio architecture 900 may be configured to communicate in accordance with an OFDMA technique, although the scope of the embodiments is not limited in this respect.

In some other embodiments, the radio architecture 900 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 9, the BT baseband circuitry 908b may be compliant with a Bluetooth (BT) connectivity standard such as Bluetooth, Bluetooth 8.0 or Bluetooth 6.0, or any other iteration of the Bluetooth Standard.

In some embodiments, the radio architecture 900 may include other radio cards, such as a cellular radio card configured for cellular (e.g., 3GPP such as LTE, LTE-Advanced or 5G communications).

In some IEEE 802.11 embodiments, the radio architecture 900 may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

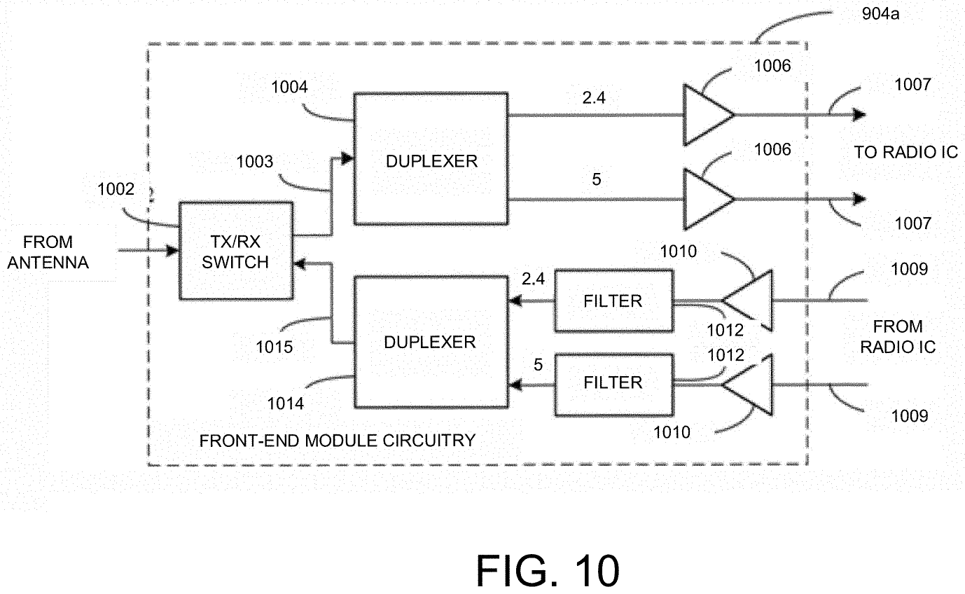

FIG. 10 illustrates WLAN FEM circuitry 904a in accordance with some embodiments. Although the example of FIG. 10 is described in conjunction with the WLAN FEM circuitry 904a, the example of FIG. 10 may be described in conjunction with the example BT FEM circuitry 904b (FIG. 9), although other circuitry configurations may also be suitable.

In some embodiments, the FEM circuitry 904a may include a TX/RX switch 1002 to switch between transmit mode and receive mode operation. The FEM circuitry 904a may include a receive signal path and a transmit signal path. The receive signal path of the FEM circuitry 904a may include a low-noise amplifier (LNA) 1006 to amplify received RF signals 1003 and provide the amplified received RF signals 1007 as an output (e.g., to the radio IC circuitry 906a-b (FIG. 9)). The transmit signal path of the circuitry 904a may include a power amplifier (PA) to amplify input RF signals 1009 (e.g., provided by the radio IC circuitry 906a-b), and one or more filters 1012, such as band-pass filters (BPFs), low-pass filters (LPFs) or other types of filters, to generate RF signals 1015 for subsequent transmission (e.g., by one or more of the antennas 901 (FIG. 9)) via an example duplexer 1014.

In some dual-mode embodiments for Wi-Fi communication, the FEM circuitry 904a may be configured to operate in either the 2.4 GHz frequency spectrum or the 5 GHz frequency spectrum. In these embodiments, the receive signal path of the FEM circuitry 904a may include a receive signal path duplexer 1004 to separate the signals from each spectrum as well as provide a separate LNA 1006 for each spectrum as shown. In these embodiments, the transmit signal path of the FEM circuitry 904a may also include a power amplifier 1010 and a filter 1012, such as a BPF, an LPF or another type of filter for each frequency spectrum and a transmit signal path duplexer 1004 to provide the signals of one of the different spectrums onto a single transmit path for subsequent transmission by the one or more of the antennas 901 (FIG. 9). In some embodiments, BT communications may utilize the 2.4 GHz signal paths and may utilize the same FEM circuitry 904a as the one used for WLAN communications.

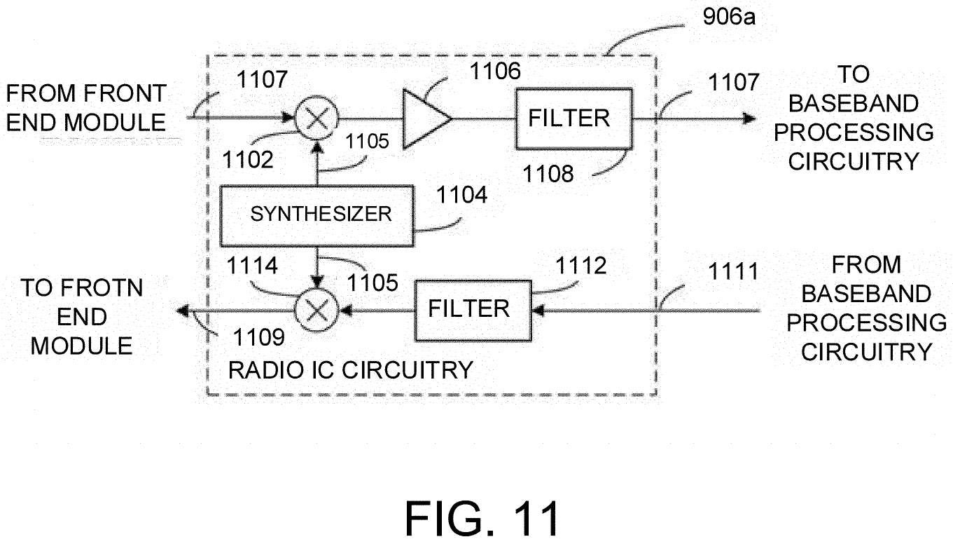

FIG. 11 illustrates radio IC circuitry 906a in accordance with some embodiments. The radio IC circuitry 906a is one example of circuitry that may be suitable for use as the WLAN or BT radio IC circuitry 906a/906b (FIG. 9), although other circuitry configurations may also be suitable. Alternatively, the example of FIG. 11 may be described in conjunction with the example BT radio IC circuitry 906b.

In some embodiments, the radio IC circuitry 906a may include a receive signal path and a transmit signal path. The receive signal path of the radio IC circuitry 906a may include at least mixer circuitry 1102, such as, for example, down-conversion mixer circuitry, amplifier circuitry 1106 and filter circuitry 1108. The transmit signal path of the radio IC circuitry 906a may include at least filter circuitry 1112 and mixer circuitry 1114, such as, for example, up-conversion mixer circuitry. Radio IC circuitry 906a may also include synthesizer circuitry 1104 for synthesizing a frequency 1105 for use by the mixer circuitry 1102 and the mixer circuitry 1114. The mixer circuitry 1102 and/or 1114 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 11 illustrates only a simplified version of a radio IC circuitry, and may include, although not shown, embodiments where each of the depicted circuitries may include more than one component. For instance, mixer circuitry 1114 may each include one or more mixers, and filter circuitries 1108 and/or 1112 may each include one or more filters, such as one or more BPFs and/or LPFs according to application needs. For example, when mixer circuitries are of the direct-conversion type, they may each include two or more mixers.

In some embodiments, mixer circuitry 1102 may be configured to down-convert RF signals 1007 received from the FEM circuitry 904a-b (FIG. 9) based on the synthesized frequency 1105 provided by synthesizer circuitry 1104. The amplifier circuitry 1106 may be configured to amplify the down-converted signals and the filter circuitry 1108 may include an LPF configured to remove unwanted signals from the down-converted signals to generate output baseband signals 1107. Output baseband signals 1107 may be provided to the baseband processing circuitry 908a-b (FIG. 9) for further processing. In some embodiments, the output baseband signals 1107 may be zero-frequency baseband signals, although this is not a requirement. In some embodiments, mixer circuitry 1102 may comprise passive mixers, although the scope of the embodiments is not limited in this respect.

In some embodiments, the mixer circuitry 1114 may be configured to up-convert input baseband signals 1111 based on the synthesized frequency 1105 provided by the synthesizer circuitry 1104 to generate RF output signals 1009 for the FEM circuitry 904a-b. The baseband signals 1111 may be provided by the baseband processing circuitry 908a-b and may be filtered by filter circuitry 1112. The filter circuitry 1112 may include an LPF or a BPF, although the scope of the embodiments is not limited in this respect.

In some embodiments, the mixer circuitry 1102 and the mixer circuitry 1114 may each include two or more mixers and may be arranged for quadrature down-conversion and/or up-conversion respectively with the help of synthesizer 1104. In some embodiments, the mixer circuitry 1102 and the mixer circuitry 1114 may each include two or more mixers each configured for image rejection (e.g., Hartley image rejection). In some embodiments, the mixer circuitry 1102 and the mixer circuitry 1114 may be arranged for direct down-conversion and/or direct up-conversion, respectively. In some embodiments, the mixer circuitry 1102 and the mixer circuitry 1114 may be configured for super-heterodyne operation, although this is not a requirement.

Mixer circuitry 1102 may comprise, according to one embodiment: quadrature passive mixers (e.g., for the in-phase (I) and quadrature phase (Q) paths). In such an embodiment, RF input signal 1007 from FIG. 11 may be down-converted to provide I and Q baseband output signals to be transmitted to the baseband processor.

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 1105 of synthesizer 1104 (FIG. 11). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1007 (FIG. 10) may comprise a balanced signal, although the scope of the embodiments is not limited in this respect. The I and Q baseband output signals may be provided to low-noise amplifier, such as amplifier circuitry 1106 (FIG. 11) or to filter circuitry 1108 (FIG. 11).

In some embodiments, the output baseband signals 1107 and the input baseband signals 1111 may be analog baseband signals, although the scope of the embodiments is not limited in this respect. In some alternate embodiments, the output baseband signals 1107 and the input baseband signals 1111 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1104 may be a fractional-N synthesizer or a fractional N/N+1 synthesizer, although the scope of the embodiments is not limited in this respect as other types of frequency synthesizers may be suitable. For example, synthesizer circuitry 1104 may be a delta-sigma synthesizer, a frequency multiplier, or a synthesizer comprising a phase-locked loop with a frequency divider. According to some embodiments, the synthesizer circuitry 1104 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1104 may be provided by a voltage controlled oscillator (VCO), although that is not a requirement. A divider control input may further be provided by either the baseband processing circuitry 908a-b (FIG. 9) depending on the desired output frequency 1105. In some embodiments, a divider control input (e.g., N) may be determined from a look-up table (e.g., within a Wi-Fi card) based on a channel number and a channel center frequency as determined or indicated by the example application processor 910. The application processor 910 may include, or otherwise be connected to, one of the example security signal converter 101 or the example received signal converter 103 (e.g., depending on which device the example radio architecture is implemented in).

In some embodiments, synthesizer circuitry 1104 may be configured to generate a carrier frequency as the output frequency 1105, while in other embodiments, the output frequency 1105 may be a fraction of the carrier frequency (e.g., one-half the carrier frequency, one-third the carrier frequency). In some embodiments, the output frequency 1105 may be a LO frequency (f_{LO}).

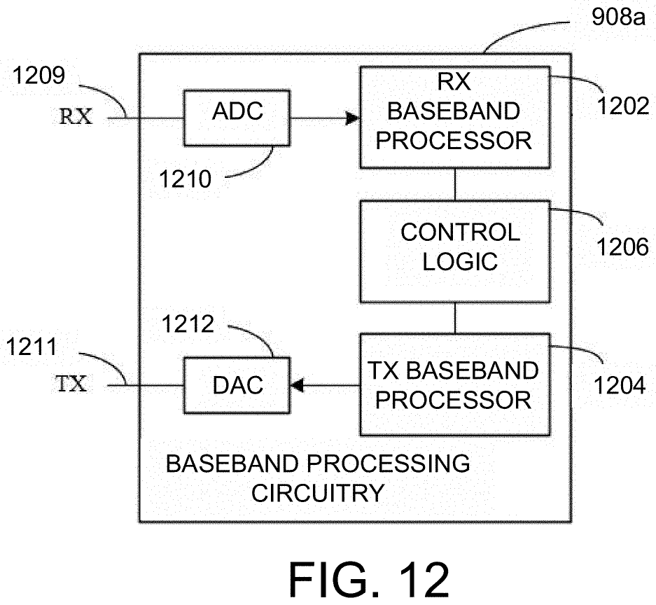

FIG. 12 illustrates a functional block diagram of baseband processing circuitry 908a in accordance with some embodiments. The baseband processing circuitry 908a is one example of circuitry that may be suitable for use as the baseband processing circuitry 908a (FIG. 9), although other circuitry configurations may also be suitable. Alternatively, the example of FIG. 11 may be used to implement the example BT baseband processing circuitry 908b of FIG. 9.

The baseband processing circuitry 908a may include a receive baseband processor (RX BBP) 1202 for processing receive baseband signals 1109 provided by the radio IC circuitry 906a-b (FIG. 9) and a transmit baseband processor (TX BBP) 1204 for generating transmit baseband signals 1111 for the radio IC circuitry 906a-b. The baseband processing circuitry 908a may also include control logic 1206 for coordinating the operations of the baseband processing circuitry 908a.

In some embodiments (e.g., when analog baseband signals are exchanged between the baseband processing circuitry 908a-b and the radio IC circuitry 906a-b), the baseband processing circuitry 908a may include ADC 1210 to convert analog baseband signals 1209 received from the radio IC circuitry 906a-b to digital baseband signals for processing by the RX BBP 1202. In these embodiments, the baseband processing circuitry 908a may also include DAC 1212 to convert digital baseband signals from the TX BBP 1204 to analog baseband signals 1211.

In some embodiments that communicate OFDM signals or OFDMA signals, such as through baseband processor 908a, the transmit baseband processor 1204 may be configured to generate OFDM or OFDMA signals as appropriate for transmission by performing an inverse fast Fourier transform (IFFT). The receive baseband processor 1202 may be configured to process received OFDM signals or OFDMA signals by performing an FFT. In some embodiments, the receive baseband processor 1202 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 9, in some embodiments, the antennas 901 (FIG. 9) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 901 may each include a set of phased-array antennas, although embodiments are not so limited.

Although the radio architecture 900 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

### Additional Notes and Examples

Example 1 includes an apparatus for an Access Point (AP), comprising: interface circuitry; and processor circuitry coupled with the interface circuitry and configured to: encode a Neighbor Discovery Protocol (NDP) Feedback Report Poll (NFRP) trigger frame in a Physical Protocol Data Unit (PPDU); and provide the PPDU to the interface circuitry for transmission to a set of one or more Stations (STAs), wherein a total bandwidth of the PPDU is divided into one or more frequency segments, the NFRP trigger frame comprises one or more User Info fields, and each User Info field corresponds to a respective frequency segment of the one or more frequency segments and provides NDP Feedback associated information for a subset of one or more STAs on the respective frequency segment.

Example 2 includes the apparatus of Example 1, wherein the total bandwidth is 20 MHz, 40 MHz, 80 MHz, 160 MHz or 320 MHz.

Example 3 includes the apparatus of Example 1, wherein the total bandwidth comprises a punctured frequency segment not used for a NDP feedback report procedure.

Example 4 includes the apparatus of Example 3, wherein the one or more frequency segments are distributed on both side of the punctured frequency segment.

Example 5 includes the apparatus of Example 1, wherein the User Info field comprises a Frequency Segment subfield for indicating a location of the respective frequency segment within the total bandwidth.

Example 6 includes the apparatus of Example 1, wherein the one or more frequency segments comprises a primary frequency segment and a secondary frequency segment, and a User Info field corresponding to the secondary frequency segment comprises a Frequency Segment subfield for indicating a location of the secondary frequency segment within the total bandwidth.

Example 7 includes the apparatus of Example 1, wherein the User Info field comprises a Starting Association Identifier (AID) subfield indicating a first AID of a range of AIDs of the subset of one or more STAs that are scheduled to respond to the NFRP trigger frame.

Example 8 includes the apparatus of Example 1, wherein the User Info field comprises a Feedback Type subfield indicating a feedback type for a NDP feedback report procedure on the respective frequency segment.

Example 9 includes the apparatus of Example 1, wherein the User Info field comprises a Multiplexing Flag subfield indicating a number of STAs that are multiplexed on a same set of tones in a same Resource Unit (RU), and a total number N_{STA} of STAs in the subset of one or more STAs that are scheduled to respond to the NFRP trigger frame is calculated by N_{STA}=18×2^{FreqSegmentsize}×(MultiplexingFlag+1), where FreqSegmentsize is a bandwidth of the respective frequency segment corresponding to the User Info field and MultiplexingFlag is a value of the Multiplexing Flag subfield.

Example 10 includes the apparatus of any of Examples 1 to 9, wherein the NFRP trigger frame further comprises a Common Info field including an Uplink (UL) Bandwidth (BW) subfield, and the UL BW subfield indicates the total bandwidth when the one or more User Info fields comprise a single User Info field and indicates a bandwidth of a first frequency segment of the one or more frequency segments when the one or more User Info fields comprise two or more User Info fields.

Example 11 includes the apparatus of Example 10, wherein when the one or more User Info fields comprise two or more User Info fields, a reserved bit in the Common Info field is used to indicate the total bandwidth.

Example 12 includes the apparatus of Example 1, wherein the NFRP trigger frame further comprises an additional User Info field to carry common NDP Feedback associated information for the set of one or more STAs.

Example 13 includes the apparatus of Example 12, wherein the additional User Info field comprises a Starting Association Identifier (AID) subfield that is set to a specified value to identify the additional User Info field as a new Info field for carrying the common NDP Feedback associated information for the set of one or more STAs.

Example 14 includes an apparatus for an Access Point (AP), comprising: interface circuitry; and processor circuitry coupled with the interface circuitry and configured to: encode one or more Neighbor Discovery Protocol (NDP) Feedback Report Poll (NFRP) trigger frames in an Aggregation Medium Access Control Protocol Data Unit (A-MPDU); and provide the A-MPDU to the interface circuitry for transmission to a set of one or more Stations (STAs), wherein a total bandwidth of a Physical Protocol Data Unit (PPDU) is divided into one or more frequency segments, and each NFRP trigger frame corresponds to a respective frequency segment of the one or more frequency segments and provides NDP Feedback associated information for a subset of one or more STAs on the respective frequency segment.

Example 15 includes the apparatus of Example 14, wherein the total bandwidth is 20 MHz, 40 MHz, 80 MHz, 160 MHz or 320 MHz.

Example 16 includes the apparatus of Example 14, wherein the total bandwidth comprises a punctured frequency segment not used for a NDP feedback report procedure.

Example 17 includes the apparatus of Example 16, wherein the one or more frequency segments are distributed on both side of the punctured frequency segment.

Example 18 includes the apparatus of Example 14, wherein the NFRP trigger frame comprises a User Info field including a Frequency Segment subfield to indicate a location of the respective frequency segment within the total bandwidth.

Example 19 includes the apparatus of Example 14, wherein the one or more frequency segments comprises a primary frequency segment and a secondary frequency segment, and a NFRP trigger frame corresponding to the secondary frequency segment comprises a User Info field including a Frequency Segment subfield to indicate a location of the respective frequency segment within the total bandwidth.

Example 20 includes the apparatus of any of Examples 14 to 19, wherein the NFRP trigger frame further comprises a Common Info field including an Uplink (UL) Bandwidth (BW) subfield, and the UL BW subfield indicates the total bandwidth when the one or more NFPR trigger frames comprise a single NFRP trigger frame and indicates a bandwidth of a first frequency segment of the one or more frequency segments when the one or more NFRP trigger frames comprise two or more NFRP trigger frames.

Example 21 includes an apparatus for a Station (STA), comprising: interface circuitry; and processor circuitry coupled with the interface circuitry and configured to: decode a Neighbor Discovery Protocol (NDP) Feedback Report Poll (NFRP) trigger frame in a Physical Protocol Data Unit (PPDU) received from an Access Point (AP), wherein a total bandwidth of the PPDU is divided into one or more frequency segments, the NFRP trigger frame comprises one or more User Info fields, and each User Info field corresponds to a respective frequency segment of the one or more frequency segments and provides NDP Feedback associated information for one or more STAs on the respective frequency segment; and encode a NDP feedback report response in a PPDU for transmission to the AP via the interface circuitry, when the NFRP trigger frame indicates that the STA is scheduled to respond to the NFRP trigger frame on a specified frequency segment.

Example 22 includes the apparatus of Example 21, wherein the total bandwidth is 20 MHz, 40 MHz, 80 MHz, 160 MHz or 320 MHz.

Example 23 includes the apparatus of Example 21, wherein the total bandwidth comprises a punctured frequency segment not used for a NDP feedback report procedure.

Example 24 includes the apparatus of Example 23, wherein the one or more frequency segments are distributed on both side of the punctured frequency segment.

Example 25 includes the apparatus of Example 21, wherein the User Info field comprises a Frequency Segment subfield for indicating a location of the respective frequency segment within the total bandwidth.

Example 26 includes the apparatus of Example 21, wherein the one or more frequency segments comprises a primary frequency segment and a secondary frequency segment, and a User Info field corresponding to the secondary frequency segment comprises a Frequency Segment subfield for indicating a location of the secondary frequency segment within the total bandwidth.

Example 27 includes the apparatus of Example 21, wherein the User Info field comprises a Starting Association Identifier (AID) subfield indicating a first AID of a range of AIDs of the one or more STAs that are scheduled to respond to the NFRP trigger frame.

Example 28 includes the apparatus of Example 21, wherein the User Info field comprises a Feedback Type subfield indicating a feedback type for a NDP feedback report procedure on the respective frequency segment.

Example 29 includes the apparatus of Example 21, wherein the User Info field comprises a Multiplexing Flag subfield indicating a number of STAs that are multiplexed on a same set of tones in a same Resource Unit (RU), and a total number N_{STA} of the one or more STAs that are scheduled to respond to the NFRP trigger frame is calculated by N_{STA}=18×2^{FreqSegmentsize}×(MultiplexingFlag+1), where FreqSegmentsize is a bandwidth of the respective frequency segment corresponding to the User Info field and MultiplexingFlag is a value of the Multiplexing Flag subfield.

Example 30 includes the apparatus of any of Examples 21 to 29, wherein the NFRP trigger frame further comprises a Common Info field including an Uplink (UL) Bandwidth (BW) subfield, and the UL BW subfield indicates the total bandwidth when the one or more User Info fields comprise a single User Info field and indicates a bandwidth of a first frequency segment of the one or more frequency segments when the one or more User Info fields comprise two or more User Info fields.

Example 31 includes the apparatus of Example 30, wherein when the one or more User Info fields comprise two or more User Info fields, a reserved bit in the Common Info field is used to indicate the total bandwidth.

Example 32 includes the apparatus of Example 31, wherein the NFRP trigger frame further comprises an additional User Info field to carry common NDP Feedback associated information for the set of one or more STAs.

Example 33 includes the apparatus of Example 32, wherein the additional User Info field comprises a Starting Association Identifier (AID) subfield that is set to a specified value to identify the additional User Info field as a new info field for carrying the common NDP Feedback associated information for the set of one or more STAs.

Example 34 includes an apparatus for a Station (STA), comprising: interface circuitry; and processor circuitry coupled with the interface circuitry and configured to: decode one or more Neighbor Discovery Protocol (NDP) Feedback Report Poll (NFRP) trigger frames in an Aggregation-Medium Access Control Protocol Data Unit (A-MPDU) received from an Access Point (AP), wherein a total bandwidth of a Physical Protocol Data Unit (PPDU) is divided into one or more frequency segments, and each NFRP trigger frame corresponds to a respective frequency segment of the one or more frequency segments and provides NDP Feedback associated information for one or more STAs on the respective frequency segment; and encode a NDP feedback report response in the PPDU for transmission to the AP via the interface circuitry, when the one or more NFRP trigger frames indicate that the STA is scheduled to respond to the one or more NFRP trigger frames on a specified frequency segment.

Example 35 includes the apparatus of Example 34, wherein the total bandwidth is 20 MHz, 40 MHz, 80 MHz, 160 MHz or 320 MHz.

Example 36 includes the apparatus of Example 34, wherein the total bandwidth comprises a punctured frequency segment not used for a NDP feedback report procedure.

Example 37 includes the apparatus of Example 36, wherein the one or more frequency segments are distributed on both side of the punctured frequency segment.

Example 38 includes the apparatus of Example 34, wherein the NFRP trigger frame comprises a User Info field including a Frequency Segment subfield to indicate a location of the respective frequency segment within the total bandwidth.

Example 39 includes the apparatus of Example 34, wherein the one or more frequency segments comprises a primary frequency segment and a secondary frequency segment, and a NFRP trigger frame corresponding to the secondary frequency segment comprises a User Info field including a Frequency Segment subfield to indicate a location of the respective frequency segment within the total bandwidth.

Example 40 includes the apparatus of any of Examples 34 to 39, wherein the NFRP trigger frame further comprises a Common Info field including an Uplink (UL) Bandwidth (BW) subfield, and the UL BW subfield indicates the total bandwidth when the one or more NFPR trigger frames comprise a single NFRP trigger frame and indicates a bandwidth of a first frequency segment of the one or more frequency segments when the one or more NFRP trigger frames comprise two or more NFRP trigger frames.

Example 41 includes a method performed at an Access Point (AP), comprising: encoding a Neighbor Discovery Protocol (NDP) Feedback Report Poll (NFRP) trigger frame in a Physical Protocol Data Unit (PPDU); and transmitting the PPDU to a set of one or more Stations (STAs), wherein a total bandwidth of the PPDU is divided into one or more frequency segments, the NFRP trigger frame comprises one or more User Info fields, and each User Info field corresponds to a respective frequency segment of the one or more frequency segments and provides NDP Feedback associated information for a subset of one or more STAs on the respective frequency segment.

Example 42 includes the method of Example 41, wherein the total bandwidth is 20 MHz, 40 MHz, 80 MHz, 160 MHz or 320 MHz.

Example 43 includes the method of Example 41, wherein the total bandwidth comprises a punctured frequency segment not used for a NDP feedback report procedure.

Example 44 includes the method of Example 43, wherein the one or more frequency segments are distributed on both side of the punctured frequency segment.

Example 45 includes the method of Example 41, wherein the User Info field comprises a Frequency Segment subfield for indicating a location of the respective frequency segment within the total bandwidth.

Example 46 includes the method of Example 41, wherein the one or more frequency segments comprises a primary frequency segment and a secondary frequency segment, and a User Info field corresponding to the secondary frequency segment comprises a Frequency Segment subfield for indicating a location of the secondary frequency segment within the total bandwidth.

Example 47 includes the method of Example 41, wherein the User Info field comprises a Starting Association Identifier (AID) subfield indicating a first AID of a range of AIDs of the subset of one or more STAs that are scheduled to respond to the NFRP trigger frame.

Example 48 includes the method of Example 41, wherein the User Info field comprises a Feedback Type subfield indicating a feedback type for a NDP feedback report procedure on the respective frequency segment.

Example 49 includes the method of Example 41, wherein the User Info field comprises a Multiplexing Flag subfield indicating a number of STAs that are multiplexed on a same set of tones in a same Resource Unit (RU), and a total number N_{STA} of STAs in the subset of one or more STAs that are scheduled to respond to the NFRP trigger frame is calculated by N_{STA}=18×2^{FreqSegmentsize}×(MultiplexingFlag+1), where FreqSegmentsize is a bandwidth of the respective frequency segment corresponding to the User Info field and MultiplexingFlag is a value of the Multiplexing Flag subfield.

Example 50 includes the method of any of Examples 41 to 49, wherein the NFRP trigger frame further comprises a Common Info field including an Uplink (UL) Bandwidth (BW) subfield, and the UL BW subfield indicates the total bandwidth when the one or more User Info fields comprise a single User Info field and indicates a bandwidth of a first frequency segment of the one or more frequency segments when the one or more User Info fields comprise two or more User Info fields.

Example 51 includes the method of Example 50, wherein when the one or more User Info fields comprise two or more User Info fields, a reserved bit in the Common Info field is used to indicate the total bandwidth.

Example 52 includes the method of Example 41, wherein the NFRP trigger frame further comprises an additional User Info field to carry common NDP Feedback associated information for the set of one or more STAs.

Example 53 includes the method of Example 52, wherein the additional User Info field comprises a Starting Association Identifier (AID) subfield that is set to a specified value to identify the additional User Info field as a new Info field for carrying the common NDP Feedback associated information for the set of one or more STAs.

Example 54 includes a method performed at an Access Point (AP), comprising: encoding one or more Neighbor Discovery Protocol (NDP) Feedback Report Poll (NFRP) trigger frames in an Aggregation Medium Access Control Protocol Data Unit (A-MPDU); and transmitting the A-MPDU to a set of one or more Stations (STAs), wherein a total bandwidth of a Physical Protocol Data Unit (PPDU) is divided into one or more frequency segments, and each NFRP trigger frame corresponds to a respective frequency segment of the one or more frequency segments and provides NDP Feedback associated information for a subset of one or more STAs on the respective frequency segment.

Example 55 includes the method of Example 54, wherein the total bandwidth is 20 MHz, 40 MHz, 80 MHz, 160 MHz or 320 MHz.

Example 56 includes the method of Example 54, wherein the total bandwidth comprises a punctured frequency segment not used for a NDP feedback report procedure.

Example 57 includes the method of Example 56, wherein the one or more frequency segments are distributed on both side of the punctured frequency segment.

Example 58 includes the method of Example 54, wherein the NFRP trigger frame comprises a User Info field including a Frequency Segment subfield to indicate a location of the respective frequency segment within the total bandwidth.

Example 59 includes the method of Example 54, wherein the one or more frequency segments comprises a primary frequency segment and a secondary frequency segment, and a NFRP trigger frame corresponding to the secondary frequency segment comprises a User Info field including a Frequency Segment subfield to indicate a location of the respective frequency segment within the total bandwidth.

Example 60 includes the method of any of Examples 54 to 59, wherein the NFRP trigger frame further comprises a Common Info field including an Uplink (UL) Bandwidth (BW) subfield, and the UL BW subfield indicates the total bandwidth when the one or more NFPR trigger frames comprise a single NFRP trigger frame and indicates a bandwidth of a first frequency segment of the one or more frequency segments when the one or more NFRP trigger frames comprise two or more NFRP trigger frames.

Example 61 includes a method performed at a Station (STA), comprising: decoding a Neighbor Discovery Protocol (NDP) Feedback Report Poll (NFRP) trigger frame in a Physical Protocol Data Unit (PPDU) received from an Access Point (AP), wherein a total bandwidth of the PPDU is divided into one or more frequency segments, the NFRP trigger frame comprises one or more User Info fields, and each User Info field corresponds to a respective frequency segment of the one or more frequency segments and provides NDP Feedback associated information for one or more STAs on the respective frequency segment; and encoding a NDP feedback report response in a PPDU for transmission to the AP, when the NFRP trigger frame indicates that the STA is scheduled to respond to the NFRP trigger frame on a specified frequency segment.

Example 62 includes the method of Example 61, wherein the total bandwidth is 20 MHz, 40 MHz, 80 MHz, 160 MHz or 320 MHz.

Example 63 includes the method of Example 61, wherein the total bandwidth comprises a punctured frequency segment not used for a NDP feedback report procedure.

Example 64 includes the method of Example 63, wherein the one or more frequency segments are distributed on both side of the punctured frequency segment.

Example 65 includes the method of Example 61, wherein the User Info field comprises a Frequency Segment subfield for indicating a location of the respective frequency segment within the total bandwidth.

Example 66 includes the method of Example 61, wherein the one or more frequency segments comprises a primary frequency segment and a secondary frequency segment, and a User Info field corresponding to the secondary frequency segment comprises a Frequency Segment subfield for indicating a location of the secondary frequency segment within the total bandwidth.

Example 67 includes the method of Example 61, wherein the User Info field comprises a Starting Association Identifier (AID) subfield indicating a first AID of a range of AIDs of the one or more STAs that are scheduled to respond to the NFRP trigger frame.

Example 68 includes the method of Example 61, wherein the User Info field comprises a Feedback Type subfield indicating a feedback type for a NDP feedback report procedure on the respective frequency segment.

Example 69 includes the method of Example 61, wherein the User Info field comprises a Multiplexing Flag subfield indicating a number of STAs that are multiplexed on a same set of tones in a same Resource Unit (RU), and a total number N_{STA} of the one or more STAs that are scheduled to respond to the NFRP trigger frame is calculated by N_{STA}=18×2^{Freqsegmentsize}×(MultiplexingFlag+1), where FreqSegmentsize is a bandwidth of the respective frequency segment corresponding to the User Info field and MultiplexingFlag is a value of the Multiplexing Flag subfield.

Example 70 includes the method of any of Examples 61 to 69, wherein the NFRP trigger frame further comprises a Common Info field including an Uplink (UL) Bandwidth (BW) subfield, and the UL BW subfield indicates the total bandwidth when the one or more User Info fields comprise a single User Info field and indicates a bandwidth of a first frequency segment of the one or more frequency segments when the one or more User Info fields comprise two or more User Info fields.

Example 71 includes the method of Example 70, wherein when the one or more User Info fields comprise two or more User Info fields, a reserved bit in the Common Info field is used to indicate the total bandwidth.

Example 72 includes the method of Example 71, wherein the NFRP trigger frame further comprises an additional User Info field to carry common NDP Feedback associated information for the set of one or more STAs.

Example 73 includes the method of Example 72, wherein the additional User Info field comprises a Starting Association Identifier (AID) subfield that is set to a specified value to identify the additional User Info field as a new info field for carrying the common NDP Feedback associated information for the set of one or more STAs.

Example 74 includes a method performed at a Station (STA), comprising: decoding one or more Neighbor Discovery Protocol (NDP) Feedback Report Poll (NFRP) trigger frames in an Aggregation-Medium Access Control Protocol Data Unit (A-MPDU) received from an Access Point (AP), wherein a total bandwidth of a Physical Protocol Data Unit (PPDU) is divided into one or more frequency segments, and each NFRP trigger frame corresponds to a respective frequency segment of the one or more frequency segments and provides NDP Feedback associated information for one or more STAs on the respective frequency segment; and encoding a NDP feedback report response in the PPDU for transmission to the AP, when the one or more NFRP trigger frames indicate that the STA is scheduled to respond to the one or more NFRP trigger frames on a specified frequency segment.

Example 75 includes the method of Example 74, wherein the total bandwidth is 20 MHz, 40 MHz, 80 MHz, 160 MHz or 320 MHz.

Example 76 includes the method of Example 74, wherein the total bandwidth comprises a punctured frequency segment not used for a NDP feedback report procedure.

Example 77 includes the method of Example 76, wherein the one or more frequency segments are distributed on both side of the punctured frequency segment.

Example 78 includes the method of Example 74, wherein the NFRP trigger frame comprises a User Info field including a Frequency Segment subfield to indicate a location of the respective frequency segment within the total bandwidth.

Example 79 includes the method of Example 74, wherein the one or more frequency segments comprises a primary frequency segment and a secondary frequency segment, and a NFRP trigger frame corresponding to the secondary frequency segment comprises a User Info field including a Frequency Segment subfield to indicate a location of the respective frequency segment within the total bandwidth.

Example 80 includes the method of any of Examples 74 to 79, wherein the NFRP trigger frame further comprises a Common Info field including an Uplink (UL) Bandwidth (BW) subfield, and the UL BW subfield indicates the total bandwidth when the one or more NFPR trigger frames comprise a single NFRP trigger frame and indicates a bandwidth of a first frequency segment of the one or more frequency segments when the one or more NFRP trigger frames comprise two or more NFRP trigger frames.

Example 81 includes a non-transitory computer-readable medium having instructions stored thereon, wherein the instructions, when executed by processor circuitry of an Access Point (AP), cause the processor circuitry to perform the method of any of Examples 41-60.

Example 82 includes an apparatus for an Access Point (AP) comprising means for performing the actions of the method of any of Examples 41-60.

Example 83 includes a non-transitory computer-readable medium having instructions stored thereon, wherein the instructions, when executed by processor circuitry of a Station (STA), cause the processor circuitry to perform the method of any of Examples 61-80.

Example 84 includes an apparatus for a Station (STA), comprising means for performing the actions of the method of any of Examples 61-80. The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled. cm What is claimed is:

1. An apparatus, comprising:
interface circuitry; and
processor circuitry coupled with the interface circuitry and configured to:
encode a Neighbor Discovery Protocol (NDP) Feedback Report Poll (NFRP) trigger frame in a Physical Protocol Data Unit (PPDU); and
provide the PPDU to the interface circuitry for transmission to a set of one or more Stations (STAs),
wherein a total bandwidth of the PPDU is divided into one or more frequency segments, the NFRP trigger frame comprises one or more User Info fields, and each User Info field corresponds to a respective frequency segment of the one or more frequency segments and provides NDP Feedback associated information for a subset of one or more STAs on the respective frequency segment.

2. The apparatus of claim 1, wherein the total bandwidth is 20 MHz, 40 MHz, 80 MHz, 160 MHz or 320 MHz.

3. The apparatus of claim 1, wherein the total bandwidth comprises a punctured frequency segment not used for a NDP feedback report procedure.

4. The apparatus of claim 3, wherein the one or more frequency segments are distributed on both side of the punctured frequency segment.

5. The apparatus of claim 1, wherein the User Info field comprises a Frequency Segment subfield for indicating a location of the respective frequency segment within the total bandwidth.

6. The apparatus of claim 1, wherein the one or more frequency segments comprises a primary frequency segment and a secondary frequency segment, and a User Info field corresponding to the secondary frequency segment comprises a Frequency Segment subfield for indicating a location of the secondary frequency segment within the total bandwidth.

7. The apparatus of claim 1, wherein the User Info field comprises a Starting Association Identifier (AID) subfield indicating a first AID of a range of AIDs of the subset of one or more STAs that are scheduled to respond to the NFRP trigger frame.

8. The apparatus of claim 1, wherein the User Info field comprises a Feedback Type subfield indicating a feedback type for a NDP feedback report procedure on the respective frequency segment.

9. The apparatus of claim 1, wherein the User Info field comprises a Multiplexing Flag subfield indicating a number of STAs that are multiplexed on a same set of tones in a same Resource Unit (RU), and a total number N_{STA} of STAs in the subset of one or more STAs that are scheduled to respond to the NFRP trigger frame is calculated by N_{STA}=18×2^{FreqSegmentsize}×(MultiplexingFlag+1), where FreqSegmentsize is a bandwidth of the respective frequency segment corresponding to the User Info field and MultiplexingFlag is a value of the Multiplexing Flag subfield.

10. The apparatus of claim 1, wherein the NFRP trigger frame further comprises a Common Info field including an Uplink (UL) Bandwidth (BW) subfield, and the UL BW subfield indicates the total bandwidth when the one or more User Info fields comprise a single User Info field and indicates a bandwidth of a first frequency segment of the one or more frequency segments when the one or more User Info fields comprise two or more User Info fields.

11. The apparatus of claim 10, wherein when the one or more User Info fields comprise two or more User Info fields, a reserved bit in the Common Info field is used to indicate the total bandwidth.

12. The apparatus of claim 1, wherein the NFRP trigger frame further comprises an additional User Info field to carry common NDP Feedback associated information for the set of one or more STAs.

13. The apparatus of claim 12, wherein the additional User Info field comprises a Starting Association Identifier (AID) subfield that is set to a specified value to identify the additional User Info field as a new Info field for carrying the common NDP Feedback associated information for the set of one or more STAs.

14. An apparatus, comprising:
interface circuitry; and
processor circuitry coupled with the interface circuitry and configured to:
encode one or more Neighbor Discovery Protocol (NDP) Feedback Report Poll (NFRP) trigger frames in an Aggregation Medium Access Control Protocol Data Unit (A-MPDU); and
provide the A-MPDU to the interface circuitry for transmission to a set of one or more Stations (STAs),
wherein a total bandwidth of a Physical Protocol Data Unit (PPDU) is divided into one or more frequency segments, and each NFRP trigger frame corresponds to a respective frequency segment of the one or more frequency segments and provides NDP Feedback associated information for a subset of one or more STAs on the respective frequency segment.

15. The apparatus of claim 14, wherein the NFRP trigger frame comprises a User Info field including a Frequency Segment subfield to indicate a location of the respective frequency segment within the total bandwidth.

16. The apparatus of claim 14, wherein the one or more frequency segments comprises a primary frequency segment and a secondary frequency segment, and a NFRP trigger frame corresponding to the secondary frequency segment comprises a User Info field including a Frequency Segment subfield to indicate a location of the respective frequency segment within the total bandwidth.

17. An apparatus, comprising:
interface circuitry; and
processor circuitry coupled with the interface circuitry and configured to:
decode a Neighbor Discovery Protocol (NDP) Feedback Report Poll (NFRP) trigger frame in a Physical Protocol Data Unit (PPDU) received from an Access Point (AP), wherein a total bandwidth of the PPDU is divided into one or more frequency segments, the NFRP trigger frame comprises one or more User Info fields, and each User Info field corresponds to a respective frequency segment of the one or more frequency segments and provides NDP Feedback associated information for one or more Stations (STAs) on the respective frequency segment; and
encode a NDP feedback report response in a PPDU for transmission to the AP via the interface circuitry, when the NFRP trigger frame indicates that the apparatus is scheduled to respond to the NFRP trigger frame on a specified frequency segment.

18. The apparatus of claim 17, wherein the total bandwidth is 20 MHz, 40 MHz, 80 MHz, 160 MHz or 320 MHz.

19. The apparatus of claim 17, wherein the total bandwidth comprises a punctured frequency segment not used for a NDP feedback report procedure.

20. The apparatus of claim 19, wherein the one or more frequency segments are distributed on both side of the punctured frequency segment.

21. An apparatus, comprising:
interface circuitry; and
processor circuitry coupled with the interface circuitry and configured to:
decode one or more Neighbor Discovery Protocol (NDP) Feedback Report Poll (NFRP) trigger frames in an Aggregation-Medium Access Control Protocol Data Unit (A-MPDU) received from an Access Point (AP), wherein a total bandwidth of a Physical Protocol Data Unit (PPDU) is divided into one or more frequency segments, and each NFRP trigger frame corresponds to a respective frequency segment of the one or more frequency segments and provides NDP Feedback associated information for one or more Stations (STAs) on the respective frequency segment; and
encode a NDP feedback report response in the PPDU for transmission to the AP via the interface circuitry, when the one or more NFRP trigger frames indicate that the apparatus is scheduled to respond to the one or more NFRP trigger frames on a specified frequency segment.

22. The apparatus of claim 21, wherein the NFRP trigger frame comprises a User Info field including a Frequency Segment subfield to indicate a location of the respective frequency segment within the total bandwidth.

23. The apparatus of claim 21, wherein the one or more frequency segments comprises a primary frequency segment and a secondary frequency segment, and a NFRP trigger frame corresponding to the secondary frequency segment comprises a User Info field including a Frequency Segment subfield to indicate a location of the respective frequency segment within the total bandwidth.
